(19) United States
(12) Patent Application Publication
(10) Pub. No.: US 2018/0093385 A1
(43) Pub. Date: Apr. 5, 2018

(54) CORNER SHEARING DEVICE

(71) Applicant: Hewlett-Packard Development Company, L.P., Houston, TX (US)

(72) Inventors: Francois K. Pirayesh, San Diego, CA (US); Xiaoqi Zhou, San Diego, CA (US); David Edmondson, San Diego, CA (US)

(21) Appl. No.: 15/563,810

(22) PCT Filed: Jul. 13, 2015
(86) PCT No.: PCT/US2015/040210

§ 371 Date: Oct. 2, 2017

(51) Int. Cl. B26B 29/06; B26D 1/00; B23D 15/00; B26D 5/10; B26F 1/44; B26F 1/38

(52) U.S. Cl. CPC B26B 29/06; B26D 1/0006; B23D 15/002; B23D 35/001; B26F 1/44; B26F 1/3806; B26D 5/10

(57) ABSTRACT

In an example implementation, a corner shearing device comprises multiple cutting profiles that are simultaneously active to each engage a distinct piece of sheet material.

### BACKGROUND

Media sheets, such as greeting cards, photo print paper, paper sheets with text and/or graphics, and other types of media cards, are usually produced and sold in the form of rectangular sheets having corners with right angles. This form having right angled corners helps to reduce manufacturing costs of the media sheets. However, consumers of such media sheets often desire different forms, such as forms having a variety of differently shaped corners. Manufacturing media sheets to have differently shaped corners involves increased costs in machine tooling and labor.

### BRIEF DESCRIPTION OF THE DRAWINGS

Examples will now be described with reference to the accompanying drawings, in which:

FIG. 1 shows a perspective view of an example corner shearing device for cutting differently shaped corners into media sheets;

FIG. 2 shows a perspective view of the stationary base of an example corner shearing device;

FIG. 3 shows an example corner shearing device comprising four simultaneously available corner cutting profiles;

FIG. 4 shows a cross sectional view of an example corner shearing device;

FIG. 5 shows the cutting action of cutting blades in an example corner shearing device.

Throughout the drawings, identical reference numbers designate similar, but not necessarily identical, elements.

### DETAILED DESCRIPTION

Market research indicates customers of some printable materials favor media sheets that have decorative corner shapes, such as rounded corners and other-shaped corners, instead of the usual square-shaped corners that are provided on rectangular media sheets. Furthermore, customers often desire differently shaped media sheets to be included within the same, or single media package. Examples of such media sheets include greeting cards, photographic print paper, paper sheets with text and/or graphics, and other types of media cards and card stock paper in a variety of sizes and weights. As noted above, manufacturing media sheets to have differently shaped corners involves increased costs related to machine tooling and labor. The increase in costs is even greater when differently shaped media sheets are to be provided within the same, or single media package.

One way to provide customers with media sheets having differently shaped corners is to offer a corner cutting device within the package of media sheets, or as a separate, stand-alone device. Providing a corner cutting device to enable the customer to cut differently shaped corners into the media sheets can be more cost effective than manufacturing the media sheets with differently shaped corners. A variety of such media sheet, corner cutting devices are known. Examples of existing corner cutting devices include those having cutting elements to cut a corner from the media sheet when operated in conjunction with a handle or other moveable structure. A base structure biased with respect to the moveable handle can receive the media sheet and enable the cutting element to cut a corner from the sheet as the handle and base converge. In some devices, the cutting element can be disassembled and/or removed from the device to enable the installation of an alternate cutting element having a different cutting shape or profile. In other devices, the cutting element can be rotated or repositioned within the device to enable access to a different cutting profile of the cutting element.

While currently available corner cutting devices offer customers some alternatives to rectangular media sheets having right-angled corners, these devices can be costly and inconvenient to use. For example, the cutting elements used in some devices have numerous components that can be complicated to assemble, disassemble, remove, replace, and so on. Such complicated cutting elements tend to increase the overall cost of the device. In addition, many devices are limited to cutting a single corner shape into one or multiple media sheets at a time, which can be inconvenient for users who want to create multiple finished sheets with varying corner shapes. Furthermore, devices that offer more than one cutting shape, or cutting profile, generally involve user interaction with the device in order to activate, access, or alternate between, the different cutting profiles.

Accordingly, examples of cutting devices described herein offer a low cost solution for users wanting to generate multiple media sheets having multiple, differently-shaped corners. In one example, a corner shearing device includes multiple cutting profiles that are simultaneously active so that each profile can engage a distinct media sheet (i.e., piece of sheet material). Each of the multiple cutting profiles has a unique cutting profile to cut a distinct shape into a piece of sheet material, and each cutting profile can engage more than one piece of sheet material. The multiple cutting profiles remain active and exposed such that they are immediately and persistently available for simultaneous cutting without user involvement to alter or manipulate the device in order to expose, activate, or otherwise enable the cutting profiles. Thus, the example corner shearing device enables the cutting of different corner shapes into different media sheets simultaneously. In one example, such a corner shearing device provides up to four corner cutting profiles.

In another example, a corner shearing device includes first and second metal blades. The blades have corresponding contours that form multiple corresponding cutting profiles. A media guide area associated with each cutting profile is to receive a media sheet and guide a corner of the media sheet to the associated cutting profile. A moveable plunger is to bring the first metal blade in sliding contact against the second metal blade to shear the corner of the media sheet according to the associated cutting profile.

In another example, a device for shearing a corner of a media sheet includes a base component to receive a media sheet at any of a plurality of active cutting profiles. The device includes a plunger component to engage the media sheet against the active cutting profile at which the media sheet is received. Engaging the media sheet against the active cutting profile shears the corner of the media sheet in a shape that corresponds with the cutting profile.

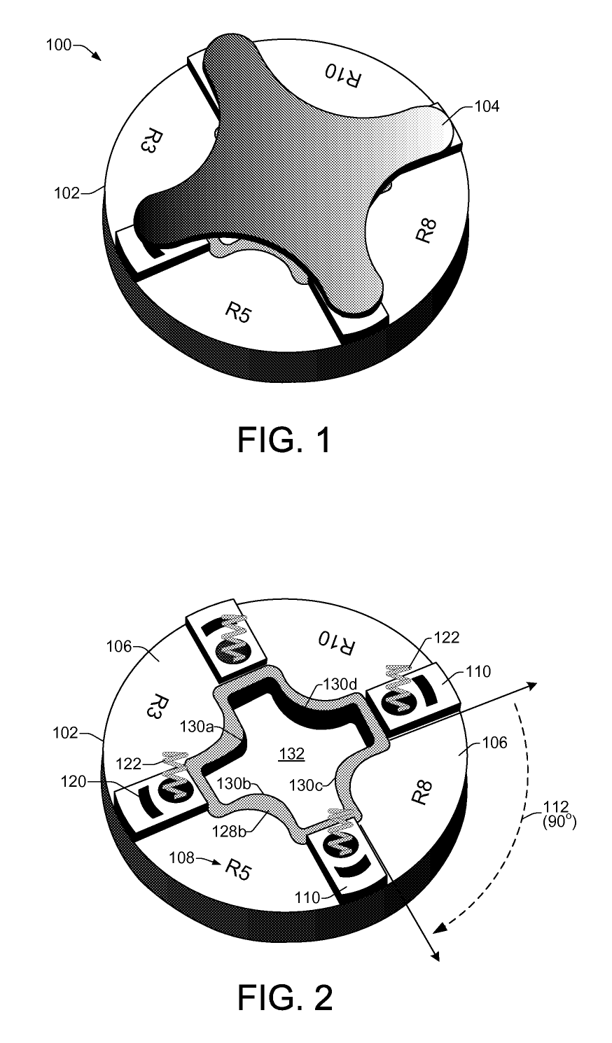

FIG. 1 is a drawing in perspective view that illustrates an example of a corner shearing device 100 for cutting differently shaped corners into media sheets. The corner shearing device 100 comprises two components whose movement with respect to one another creates a shearing action that cuts a shape into the corner of a piece of sheet material. One component of device 100 comprises a base assembly 102 that is to receive pieces of sheet material, or media sheets (e.g., greeting cards, photographic print paper, paper sheets, other printable media cards or papers, etc.). Another component of device 100 comprises a plunger assembly 104 that is movable toward the base assembly 102 to bring together metal cutting blades of the device 100 in order to shear off the corners of the media sheets in shapes that correspond with cutting profiles formed by the contours of the cutting blades. As discussed below, the moveable plunger assembly 104 comprises a shell covering and an underlying moveable plunger.

In the example corner shearing device 100 of FIG. 1, the base assembly 102 is a stationary base assembly 102 (referred to alternately as the stationary base 102), while the plunger assembly 104 is a moveable plunger assembly 104. Thus, the corner shearing device 100 can be positioned such that the stationary base 102 is disposed against a surface, such as a table top, and the moveable plunger assembly 104 can be moved toward the stationary base 102 through the application of a compressive force, such as a user's hand pushing the moveable plunger assembly 104 downward. While the example corner shearing device 100 is described herein as having a stationary base assembly 102 and a moveable plunger assembly 104, the designation as to which assembly is stationary and which assembly is moveable is arbitrary. That is, other configurations and/or designations for the base and plunger assemblies of device 100 are possible that involve movement of the base and plunger assemblies toward one another in order to shear off the corner of a piece of sheet material. Thus, in other examples of a corner shearing device 100, one or both of the base assembly and plunger assembly may be moveable such that either or both can be moved with compressive force toward one another.

FIG. 2 is a drawing that shows a perspective view of the stationary base 102 of the example corner shearing device 100 of FIG. 1. In the FIG. 2 illustration, the moveable plunger assembly 104 has been removed from the device 100 in order to provide a better view of the stationary base 102. As seen in FIG. 2, the stationary base 102 comprises multiple media guide areas 106. Media guide areas 106 are generally flattened areas that form a plane around the perimeter of the stationary base 102 onto which media sheets (pieces of sheet material) can be positioned in preparation to have the corners of the media sheets cut or sheared into different shapes using different cutting profiles of the corner shearing device 100.

Each media guide area 106 can include a corner cutting profile indicator 108, alternately referred to as a corner shape indicator 108. A corner shape indicator 108 can indicate characteristics of the cutting profile, or cutting shape, that is associated with the particular media guide area 106. For example, a corner shape indicator 108 may provide information signifying a circular cutting profile of a certain size. Thus, as shown in the stationary base 102 of FIG. 2, each media guide area 106 includes a corner shape indicator 108 that indicates a circular cutting shape having a particular radius of curvature (i.e., R3, R5, R8, R10). Examples of some popular curvatures include corner diameters of 5 and 10 millimeters. While the examples shown herein demonstrate circular cutting profiles with varying curvature sizes, a variety of other corner cutting profiles are possible. Such corner cutting profiles can include, but are not limited to, star shaped profiles, heart shaped profiles, lace shaped profiles, and so on.

Each media guide area 106 includes two associated media guides 110 that enable proper alignment of the corner of a media sheet within the associated media guide area 106. Because most media sheets (e.g., paper sheets, greeting cards, photographic print paper, paper sheet, etc.) are manufactured having squared corners (i.e., 90 degree or right angle corners), the media guides 110 are positioned on the stationary base 102 to form 90 degree media entry angles 112. The 90 degree media entry angles 112 facilitate positioning of the squared corners of media sheets into each media guide area 106 and a proper alignment of the media sheet corners with the associated corner cutting profile.

The figures and related discussion herein demonstrate an example corner shearing device 100 comprising four simultaneously available corner cutting profiles, each with an associated media guide area 106. This example implementation of the device 100 having four corner cutting profiles is enabled in part by the circular design of the shearing device 100 whose 360 degree circumference readily accommodates the right angle corners (i.e., 90 degree corners) of up to four different media sheets. The circular design enables the positioning of up to four media guide areas 160 adjacent to one another, along with the associated media guides 110 that separate the media guide areas 160 and provide the 90 degree media entry angles 112. It is noted, however, that while the example corner shearing device 100 is illustrated herein as having four corner cutting profiles and associated media guide areas 106, other configurations of a corner shearing device 100 are possible and contemplated. For example, other implementations of a corner shearing device can include configurations having fewer than four corner cutting profiles with corresponding media guide areas disposed around the circumference of the device.

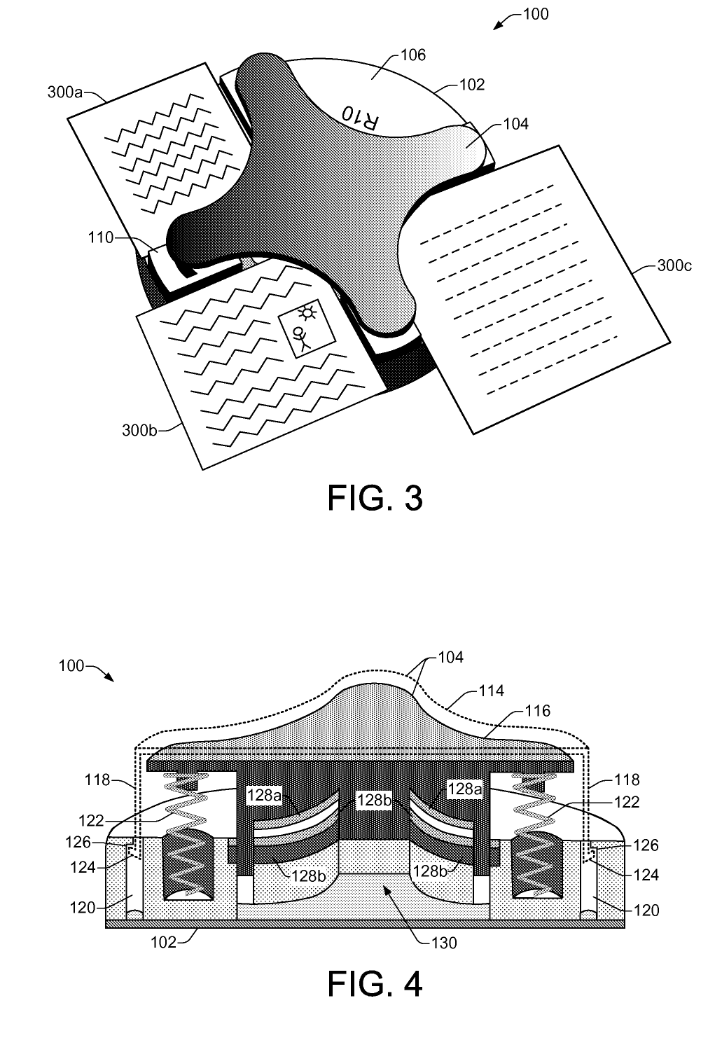

FIG. 3 illustrates the example corner shearing device 100 comprising four simultaneously available corner cutting profiles in a use case where multiple shapes (i.e., four shapes) can be cut into different media sheets at the same time. In the FIG. 3 example, multiple media sheets 300 (illustrated as media sheets 300a, 300b, 300c), are positioned around the corner shearing device 100 at different media guide areas 106. It is noted that the media sheets 300 shown in FIG. 3 are not intended to be to scale, and that they would most likely be larger in size compared with the corner shearing device 100. Because each of the media guide areas 106 is associated with a different corner cutting profile, positioning and cutting the media sheets 300 in the manner shown will result in differently shaped corners for each of the three media sheets 300a, 300b, and 300c. For example, the three different corner cutting profiles can be substantially circular shapes that each have a different radius of curvature. As shown in FIG. 3, a fourth cutting profile (R10) is also available, but is not being used in this example. Thus, with a single cutting action, as described below, different corner shapes can be formed in up to four different media sheets simultaneously. Furthermore, although not illustrated in FIG. 3, the corner shearing device 100 can also cut more than a single media sheet at one time positioned within a media guide area 106. Thus, in some examples, a media sheet such as media sheet 300a, may comprise a stack of multiple media sheets (e.g., 1-5 media sheets).

FIG. 4 shows a cross sectional view of an example corner shearing device 100. Referring now primarily to FIGS. 2 and 4, the moveable plunger assembly 104 comprises a shell 114 and a moveable plunger 116. The shell 114 is illustrated transparently using dashed lines so as not to obscure the underlying moveable plunger 116. The shell 114 covers the plunger 116 and provides a contact area that facilitates the application of a compressive force, such as contact pressure from a user's hand, to move the plunger assembly 104 from an initial resting position toward the stationary base 102 to a secondary cutting position.

The shell 114 comprises shell posts 118 inserted into guide holes 120 of the stationary base 102 that help to guide the plunger assembly 104 evenly toward the stationary base 102. When the compressive force is reduced or removed, the shell posts 118 guide the plunger assembly 104 from the cutting position back to its initial resting position. The plunger assembly 104 moves back to its initial resting position, and is maintained in this resting position, under a repulsive force provided by an elastic element 122 such as a coil spring 122. As shown in the example corner shearing device 100 of FIGS. 2 and 4, four coil springs 122 are positioned evenly around the perimeter of the device 100. The springs 122 enable the moveable plunger assembly 104 and stationary base 102 to converge to a cutting position when a compressive force applied to the shell 114 overcomes the repulsive force of the springs 122. When the compressive force is removed, the repulsive force of the springs 122 push the plunger assembly 104 and stationary base 102 back apart from one another to their initial resting positions. The shell posts 118 include hooks 124 or other fastening mechanisms to prevent the plunger assembly 104 and stationary base 102 from separating completely. The movement of the plunger assembly 104 away from the base 102 stops when the hooks 124 engage an inner lip 126 within the guide holes 120.

Referring still to FIGS. 2 and 4, cutting blades 128 (illustrated as first cutting blade 128a and second cutting blade 128b) are contoured to form multiple cutting profiles 130 (illustrated as cutting profiles 130a, 130b, 130c, and 130d) within the corner shearing device 100. The cutting blades 128 are implemented, for example, as sheet metal cutting blades 128. While the examples herein discuss cutting blades 128 formed from sheet metal, other appropriate materials suitable to achieve shearing of media sheet corners are possible. Such materials may include, for example, carbon, carbide, ceramics, alloys, and so on.

The first cutting blade 128a is coupled (e.g., fastened, glued, affixed) to the moveable plunger 116. The second cutting blade 128b is coupled to the stationary base 102. The cutting blades each form a continuous structure that folds back on itself and lines the perimeter of an inner cavity 132 of the corner shearing device 100. The cutting blades 128 are oriented vertically, such that they form a wall that is perpendicular to the plane of the media guide areas 106, and perpendicular to the plane of a media sheet 300 positioned within a media guide area 106. The multiple cutting profiles 130a, 130b, 130c, and 130d, face inward toward the inner cavity 132. While the first cutting blade 128a is not fully illustrated, its shape corresponds with the shape of the second cutting blade 128b, such as the shape of cutting blade 128b as shown in FIG. 2. The corresponding shape of the blades 128a and 128b enables the multiple cutting profiles 130a, 130b, 130c, and 130d, to shear the corners of media sheets 300 as the blades slide past each other when the moveable plunger 116 is pushed down toward the stationary base 102.

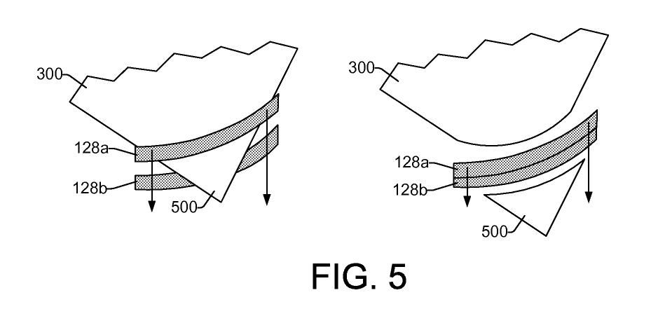

FIG. 5 illustrates the cutting action of the cutting blades 128 in an example corner shearing device 100. In FIG. 5, a media sheet 300 is shown as it would be positioned in a media guide area 106 (e.g., see FIGS. 2 and 3) such that the corner 500 of the media sheet 300 protrudes between the two cutting blades 128a and 128b. Referring to FIG. 5, and also to FIGS. 2-4, as a compressive force moves the moveable plunger 116 toward the stationary base 102, the edges of the cutting blades 128a and 128b slide together and past one another to provide a shearing effect that cuts off the corner 500 of the media sheet 300 in a shape that corresponds with the cutting profile 130 of the blades. The sheared corner 500 piece falls into the inner cavity 132 of the device 100. In some examples, the shearing effect of the blades 128 is improved by angling the blades at different angles with respect to one another.

What is claimed is:

1. A corner shearing device comprising:
multiple cutting profiles that are simultaneously active to each engage a distinct piece of sheet material.

2. A device as in claim 1, wherein each of the multiple cutting profiles comprises a unique cutting profile to cut a distinct shape into a corner of a piece of sheet material.

3. A device as in claim 1, wherein the multiple cutting profiles comprise four cutting profiles disposed approximately 90 degrees apart from one another.

4. A device as in claim 3, wherein each cutting profile has a substantially circular shape with a different radius of curvature than the other cutting profiles.

5. A device as in claim 1, further comprising:
a first blade coupled to a moveable plunger;
a second blade coupled to a stationary base;
wherein the first and second blades are shaped to provide the multiple cutting profiles.

6. A device as in claim 5, wherein the stationary base comprises:
a media guide area associated with each cutting profile; and
two media guides associated with each media guide area to align a corner of a media sheet with a cutting profile as the media sheet is received at the media guide area.

7. A device as in claim 6, further comprising:
an elastic object to provide a repulsive force that keeps the moveable plunger and the stationary base apart from one another in an initial resting position, and allows the moveable plunger and stationary base to converge together in a secondary cutting position when a compressive force is applied to the moveable plunger that is large enough to overcome the repulsive force.

8. A device as in claim 7, wherein the elastic object comprises a coil spring.

9. A device as in claim 7, further comprising:
a shell coupled to the moveable plunger to facilitate application of the compressive force;
a guide pin integral to the shell to guide the moveable plunger toward the stationary base when the compressive force overcomes the repulsive force; and
a hook on the guide pin to prevent the moveable plunger and stationary base from uncoupling when the compressive force is removed.

10. A corner shearing device comprising:
first and second metal blades, the blades having corresponding contours that form multiple corresponding cutting profiles;
a media guide area associated with each cutting profile to receive a media sheet and to guide a corner of the media sheet to the associated cutting profile; and
a moveable plunger to bring the first metal blade in sliding contact against the second metal blade to shear the corner of the media sheet in a shape according to the associated cutting profile.

11. A device as in claim 10 wherein the first metal blade is coupled to the moveable plunger, and the second metal blade is coupled to a stationary base.

12. A device as in claim 10, wherein each media guide area forms a plane for positioning a corner of a media sheet, and wherein the metal blades comprise sheet metal blades oriented perpendicular to the planes.

13. A device as in claim 11 further comprising:
a shell to receive a compressive force that moves the moveable plunger toward the stationary base; and
a spring to repel the moveable plunger away from the stationary base when the compressive force is removed.

14. A device as in claim 13, wherein the shell comprises shell posts inserted into guide holes of the stationary base to guide the moveable plunger evenly toward the stationary base and to prevent the moveable plunger and stationary base from uncoupling when the compressive force is removed.

15. A device for shearing a corner of a media sheet, comprising:
a base component to receive a media sheet at any of a plurality of active cutting profiles; and
a plunger component to engage the media sheet against the active cutting profile at which the media sheet is received.
